(19) United States
(12) Patent Application Publication
(10) Pub. No.: US 2014/0143734 A1
(43) Pub. Date: May 22, 2014

(54) BUSINESS OBJECT EXPLORER

(71) Applicants: Florian Jann, Heidelberg (DE); Joachim Sander, Mannheim (DE); Thomas Gross-Boelting, Walldorf (DE)

(72) Inventors: Florian Jann, Heidelberg (DE); Joachim Sander, Mannheim (DE); Thomas Gross-Boelting, Walldorf (DE)

(21) Appl. No.: 13/683,614

(22) Filed: Nov. 21, 2012

(51) Int. Cl. G06F 3/0481

(52) U.S. Cl. CPC G06F 3/0481
USPC 715/853

(57) ABSTRACT

A method and system for displaying an business object explorer within a development environment includes displaying a control bar including actionable items; in response to selection of an actionable item, displaying a list of business objects in a tree area, the business objects including at least one expandable business object; and in response to selection of the at least one expandable business object, expanding the at least one expandable business object to display a hierarchical tree including attributes of the selected at least one expandable business object in the tree area.

### FIELD OF THE DISCLOSURE

The present disclosure is directed to systems and methods for a development environment that allows a development partner of a software vendor to easily access information of business objects, and in particular, directed to a business object explorer that displays information for the partner to develop applications.

### BACKGROUND

Unlike consumer software, business software applications of a vendor tend to require customization for the particular needs of a customer and are therefore often sold to the customer through a partner of the vendor. The vendor may provide the partner with a development environment that allows the partner to build additional functionalities to a business application to meet the specification of the customer. The partner may use business objects to build these additional functionalities. A business object is a data object (or entity) that includes a set of variables (or attributes) and associations with other business objects. The relationship among business objects defines the interactions among these business objects. Each business object may include business data and processes associated with the business data. The business data may belong to certain data type. The processes may include action such as release or query. Business objects may be in certain states that can be changed by the business processes.

The business objects may be stored in a repository from which a user may retrieve the business object. For certain applications, the vendor may provide enhancement options, or positions in the business object, at which enhancement to the business object may be added. The business object, data type, and enhancement options are the elements that a developer needs for creating additional functionalities to the business application.

The vendor may release or expose certain business objects to the partner so that the partner can access, reuse, or even extend the business objects, data type and enhancement options. To create meaningful functionalities, partner developers need to know detailed information about the structure, behavior and function of these business objects. Current art provides information of the business objects with a flat list of table which is cumbersome for the partner developers to use.

### BRIEF DESCRIPTION OF THE DRAWINGS OF THE EXAMPLE EMBODIMENTS

FIG. 1 illustrates a system for providing a business object explorer to a partner according to an embodiment of the present disclosure.

FIG. 2 is a detailed system diagram for providing information of business objects to a partner to an embodiment of the present disclosure.

FIGS. 3A-3B are two layouts of a business object explorer according to an embodiment of the present disclosure.

FIGS. 4A-4B are a control bar according to an embodiment of the present disclosure.

FIGS. 5A-5B are a list of business objects according to an embodiment of the present disclosure.

FIG. 6 is a flow diagram of displaying the business object explorer according to an embodiment of the present disclosure.

### DETAILED DESCRIPTION OF THE EXAMPLE EMBODIMENTS

There is a need for tools that facilitate partners' access to information of released business objects. Instead of using a flat list of business objects, embodiments of the present disclosure provide partners with a business object explorer through which partners may easily access information about business objects.

Embodiments of the present disclosure may include a method for displaying an business object explorer within a development studio includes displaying, by a processor, a control bar including actionable items; in response to selection of an actionable item, displaying, by the processor, a list of business objects in a tree area, the business objects including at least one expandable business object; and in response to selection of the at least one expandable business object, expanding the at least one expandable business object to display a hierarchical tree including attributes of the selected at least one expandable business object in the tree area.

Embodiments of the present disclosure may include a computer system that includes a processor that is configured to display an business object explorer within a development studio and to: display a control bar including actionable items the business objects including at least one expandable business object; and in response to selection of the at least one expandable business object, expand the at least one expandable business object to display a hierarchical tree including attributes of the selected at least one expandable business object in the tree area.

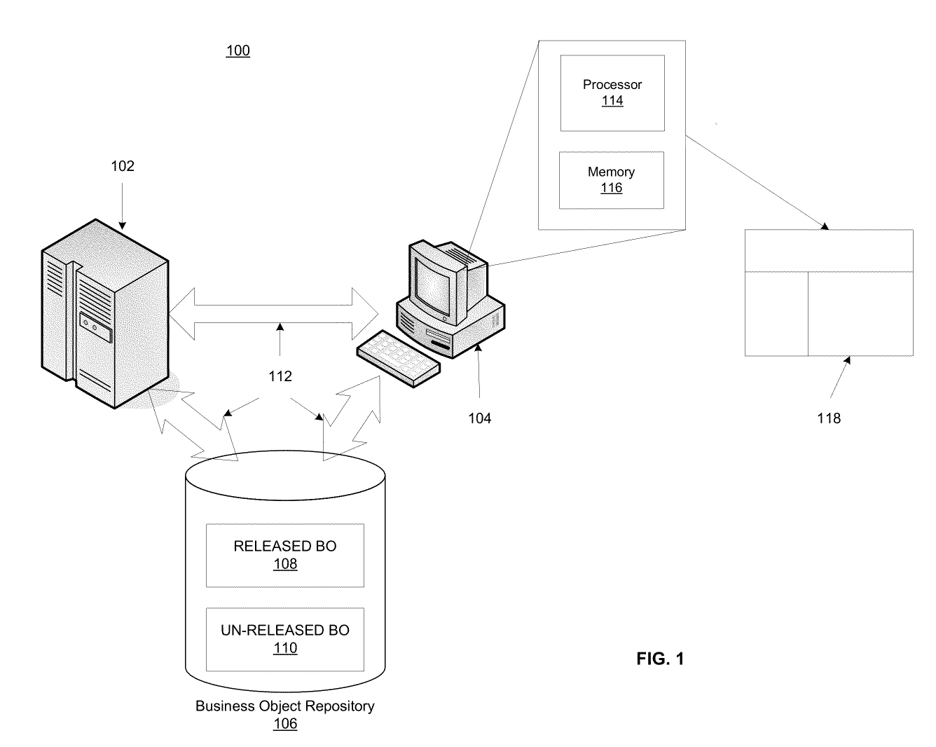

FIG. 1 illustrates a system for providing a business object explorer to a partner according to an embodiment of the present disclosure. The system 100 may include a first computer 102 of the vendor, a second computer 104 of a partner for the vendor, and a storage database 106 that is a business object repository. The first computer 102, second computer 104, and the storage database 106 may be interconnected through a network 112. The vendor may create business applications that are composed of business objects which may be stored in the business object repository of the database storage 106. A first portion of the business objects (“released business objects” 108) may be exposed to the partner so that the partner may further modify these released business objects to customize a business application for its customer. A second portion of the business objects (“un-released business objects” 110) is off-limit to the partner. A developer of the partner may access the released business objects 108 via the second computer 104. The second computer may include a processor 114 and a memory device 116. To facilitate the developer, embodiments of the present disclosure may configure the processor 114 with a business object explorer through which the developer may conveniently access information of the released business objects.

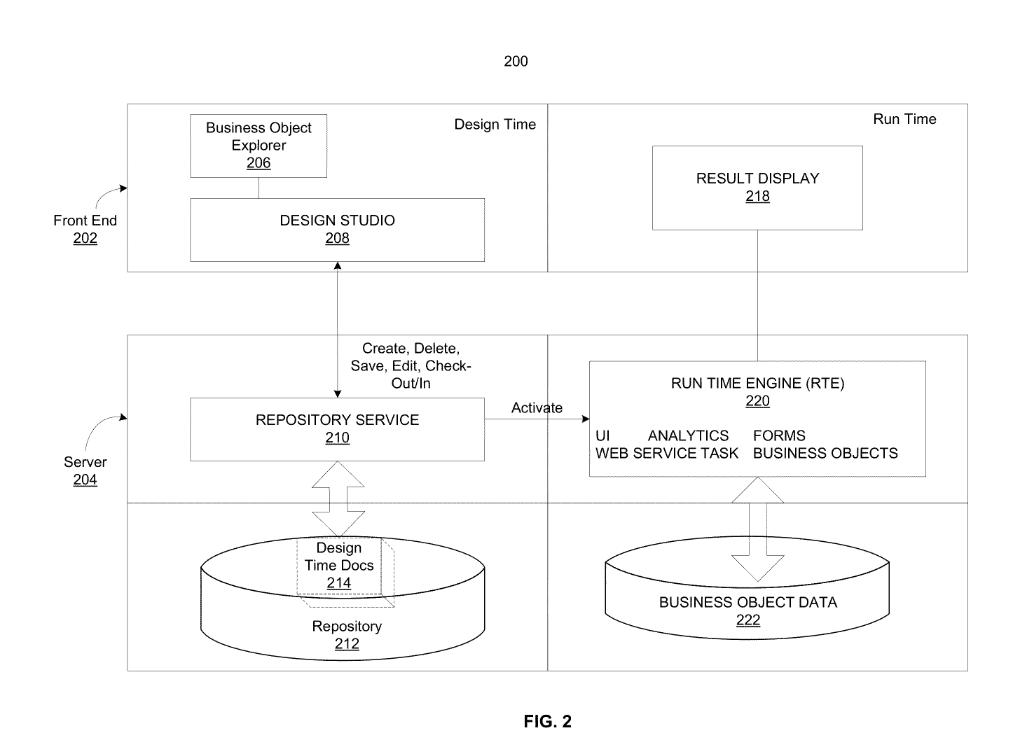

FIG. 2 is a detailed system diagram for providing information of business objects to a partner according to an embodiment of the present disclosure. The system 200 may include a front end 202 and a server 204 that both may have a design time state and a run time state. The front end 202 may include a computer of the partner that is configured to support, in the design time, a design studio 208 and a business object explorer 206. The business object explorer 206 may be a graphic user interface (GUI) through which the developer may accesses business objects and the contents therein. The design studio 208 is a development environment (such as an SDK) that enables partner developers to build additional functionalities on top of a business application. The partner developers may issue “create,” “delete,” “save,” “edit,” “check-in,” and “check-out” commands which are directed at business objects for creating these additional functionalities. In this way, the partner developers may access, reuse, or extend existing business objects. The detailed information that is helpful to the developers may be obtained from the server 202 through a network.

The server 202 may include a processor that is configured to execute the repository service module 210. In one embodiment, the repository service module 210 may be a web service that is configured to provide communication between the design studio 208 and a repository database 212 which stores design time documents 214. These design time documents 214 contain information of the business objects that may be used by the developers. Thus, the repository service module 210 may, at a first end, communicate with the design studio 208, and at a second end, communicate with the repository database 212. The developers, during design time, may look for information of business objects using the business object explorer 206 which accesses the design documents 214 through the design studio 208 and the repository service 210.

After the developers completed the design, the complete business objects that embody the additional functionalities may be activated for run time. During the run time, the processor of the server 202 may be configured with a run time engine (RTE) to execute the business application. The RTE may retrieve business object data from a database storage 222 for the business objects in the executed business application. The RTE 220 may also instantiate business objects and display the results to a user in a result display 218 in the front end. To this end, the RTE 220 may provide supports for forms, analytics and web services for executing the business application.

In one embodiment of the present disclosure, the business object explorer 206 may be implemented as an integrated view of the design studio so that the developers have all the information at the place they are needed. The business object explorer 206 may be initiated by activation of a menu item (such as a view menu) on the design studio 208, or alternatively, the business object explorer 206 may be initiated by selecting an object or sub-element of an object inside a coding view of the design studio 208, or alternatively, the business object explorer 206 may be initiated by a keyboard short cut.

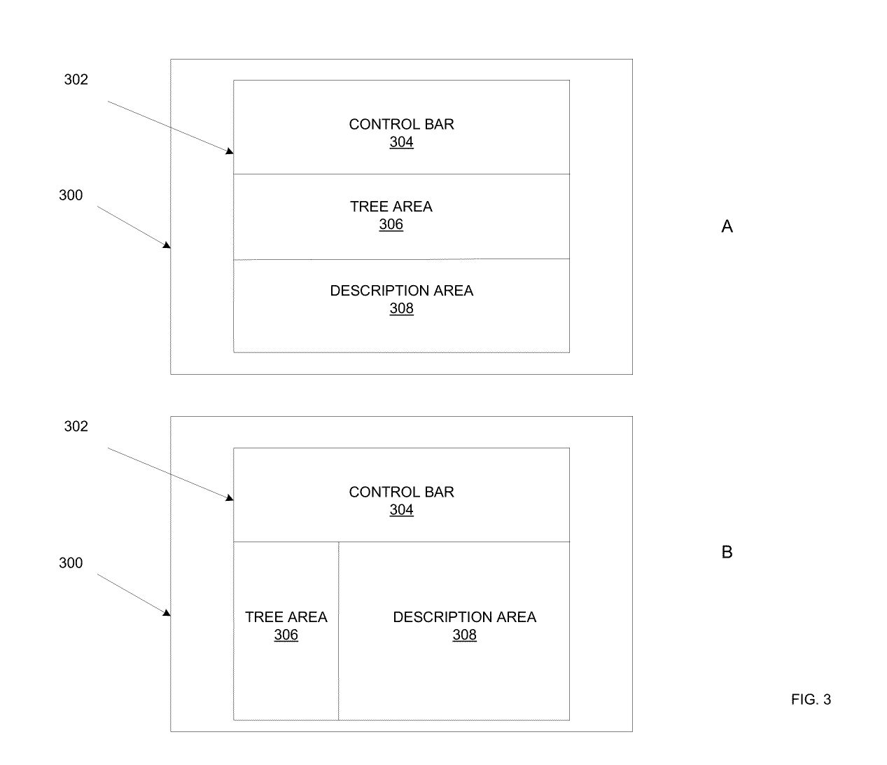

The view of the business object explorer 206 may include a control bar, a tree area and a detail/description area. The control bar may be at a fixed position, while the tree area and the detail/description area may be resized and reconfigured as suitable for the user. FIGS. 3A-3B are two layouts of a business object explorer according to an embodiment of the present disclosure. In these figures, the design studio 300 may include a view of the business object explorer 302 which includes a control bar 304, a tree area 306, and a description area 308. In one embodiment as shown in FIG. 3A, the control bar is at the top, while the tree area is above the detail/description area. In an alternative embodiment as shown in FIG. 3B, the control bar is at the top, while the tree area and the detail/description area are sided by side.

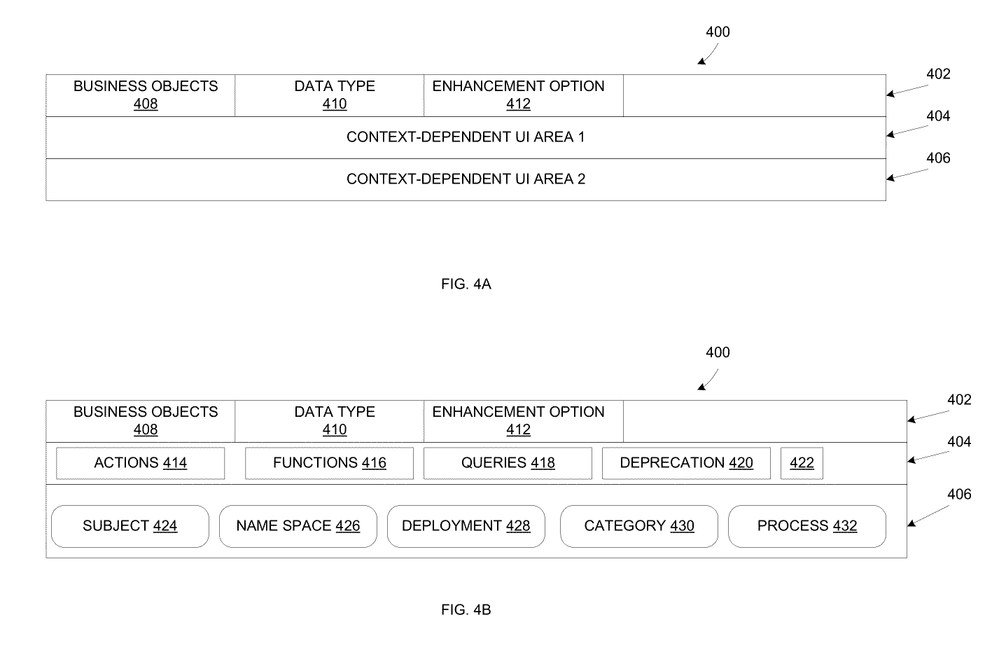

The control bar may include a first area for displaying a number of selectable items and a number of second content-dependent areas for displaying items based on the selection of the selectable items in the first area. FIG. 4A is a control bar to an embodiment of the present disclosure. As shown in FIG. 4A, the control bar 400 may include a first area 402 which may include selectable items. In one embodiment, the selectable items may include a business objects tab 408, a data type tab 410, and an enhancement option tab 412. Further, the control bar 400 may include content-dependent areas 404, 406 that may display actionable items such as navigation/search filters and toggle options based on the selection of tabs in the first area. For example, if the business objects tab 408 is selected by a developer, areas 404, 406 may display a first set of actionable items relating to display business objects in the tree area 306 and description area 308; if the data type tab 410 is selected, areas 404, 406 may display a second set of actionable items relating to displaying data type in the tree area 306 and description area 308; if the enhancement option tab 412 is selected, areas 404, 406 may display a third set of actionable items relating to displaying enhancement options in the tree area 306 and description area 308.

If the business objects button 408 is activated, the tree area 306 may display a list of business objects while areas 404, 406 may display actionable items. In one embodiment, as shown in FIG. 4B, area 404 may display a number of toggle buttons 414-422 that may cause changes to the display of attributes of business objects in the tree area 306. The toggle buttons may include an actions button 414, a functions button 416, a queries button 418, a deprecation button 420, and change view button 422. By toggling the actions button 414, actions associated with business objects may show or hide. By toggling the functions button 416, functions associated with business objects may show or hide. By toggling the queries button 418, queries associated with business objects may show or hide. By toggling the deprecation button 420, the developer may render a valid business object invalid. By toggling the change view 422, the tree area 306 and description area 308 may switch between a vertical view as shown in FIG. 3A to a horizontal view as shown in FIG. 3B.

In one embodiment, in response to the activation of the business object button 408, area 406 may display a number of search fields 424-432 through which the developer may search for a business object and focus on the business object. The search fields may include a business object name search 424, a namespace filter 426, a deployment filter 428, an object category search 430, and a process filter 432. The business object name search may include an input field where the developer may enter a business object name and search for the business object which, when found, may be displayed in the tree area 306. The namespace filter 426 may be a combobox that may list groups of business objects according to logical groups. The deployment filter 428 may be a combobox that includes selections for listing business objects according to groups of different geographic locations (such as countries) and/or levels of accessibility. The object category search 430 may be a combobox which includes selections for listing business objects according to categories. The process filter 432 may be a combobox which may include selections for listing business objects according to the processes associated with the business objects.

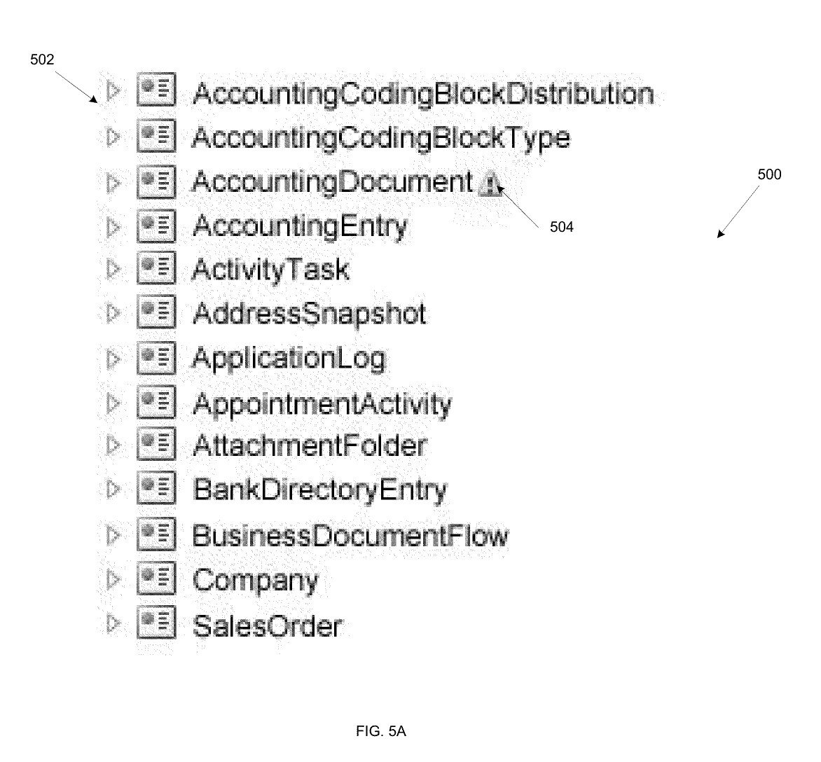

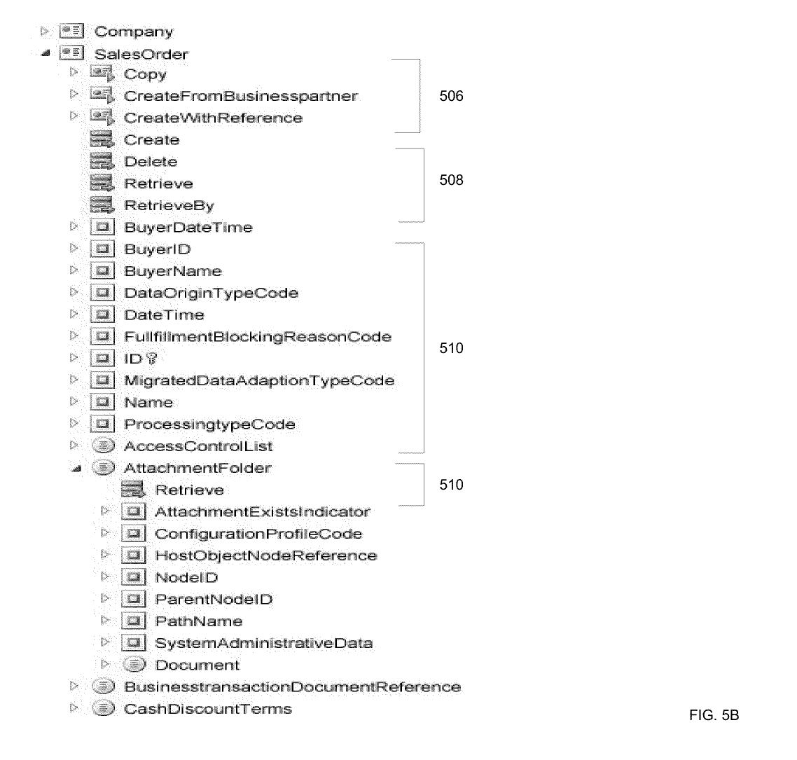

In one embodiment, in response to the activation of the business object button 408, the tree area 306 may display a list of all released business objects. FIG. 5A is an example of a list 500 of released business objects according to an embodiment of the present disclosure. In response to a user activation, one or more of the released business objects in the list may be expanded. The displayed list may include a first indicator 502 indicating whether a released business object is expandable and a second indicator 504 indicating whether the released business object is valid. When the business object is expanded, the tree area 306 may display the expanded business object as an expanded tree, thereby displaying the list in the form of a hierarchical tree. FIG. 5B is a portion of the hierarchical tree that shows attributes of the expanded business object “SalesOrder.” The attributes may include actions 506 that are specific to the particular business object, functions 508 that are generic to all business objects, elements 510 that include data objects for the business object, and nodes 512 that may be a group or a container for sub-objects. The nodes may be further expanded to expose attributes of the sub-objects. Additional information about the business objects may also be displayed by using additional indicators. In one embodiment, a further indicator may be displayed next to a business object to indicate a type of the business object, and another further indicator may be displayed next to a business object to indicate access rights to the business object (such as read-only or read-and-write). In one embodiment, an indicator may be displayed next to a business object so that when a cursor is placed over the indicator, a summary of the content in the business object (such as the number of elements) may be displayed in a tooltip.

In one embodiment, the description area 308 may display textual description on a business object or a sub-object that is selected in the tree area 306. The textual information may be supplied from the repository database.

If the data type button 416 on the control bar 400 is activated, area 404 may be configured to display a data-type name search, a namespace filter, and a base-data type filter. The data-type name search may be an input field to which the developer may enter a data-type name to search for business objects that may include the data type. The namespace filter may be a combobox that may list data types according to logical groups. The base-data type filter may be a combobox that may include selections of data types that are available in business objects. The tree area 306 may display a list of selected data types, or alternatively, a tree of the selected data types. The description area 308 may display textual information of the selected data type.

If the enhancement option button 418 on the control bar 400 is activated, area of 406 may display actionable items that may be used to configure the display in the tree area 306. The tree area 306 may display a list of released enhanced options. The partner developer may use the released enhanced option to create customized attributes to business objects. In one embodiment, area 406 may include an enhanced option name search, a namespace search, and a usage filter. The enhanced option name search may be an input field to which an enhanced option name may be entered for searching enhanced options by name. The namespace filter may be a combobox that may list enhanced options according to logical groups. The usage filter may be a combobox that may list enhanced options according to their usages. The partner developer may select the enhanced options displayed in the tree area to add attributes to business objects.

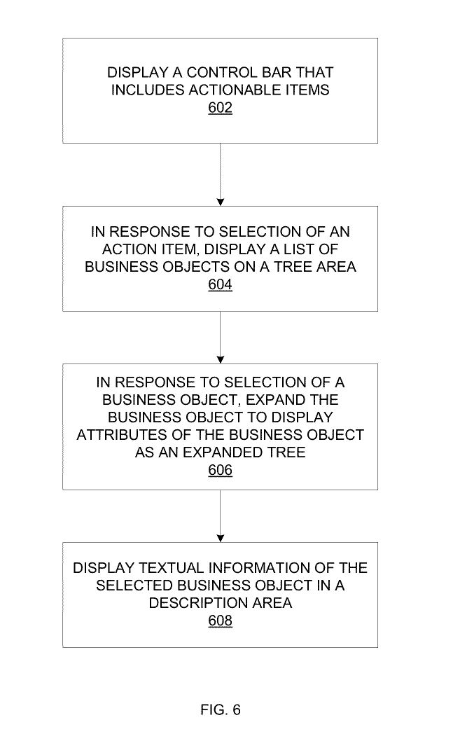

FIG. 6 is a process of displaying the business object explorer according to an embodiment of the present disclosure. At 602, in response to selection of view panel in the developer studio, a hardware processor may be configured to display a control bar that may include actionable items. At 604, in response to selection of an actionable item, the processor may be configured to display a list of business objects in a tree area, in which one or more of the business objects may be expandable. At 606, in response to selection of an expandable business object displayed in the tree area, the processor may be configured to display a hierarchical tree including the list and attributes of the selected business object in the tree area. At 608, the processor may be configured to further display textual information of the business object in a description area.

Although the present disclosure has been described with reference to particular examples and embodiments, it is understood that the present disclosure is not limited to those examples and embodiments. Further, those embodiments may be used in various combinations with and without each other. The present disclosure as claimed therefore includes variations from the specific examples and embodiments described herein, as will be apparent to one of skill in the art.

What is claimed is:

1. A computer-implemented method for displaying an business object explorer within a development studio, comprising:
displaying, by a processor, a control bar including actionable items;
in response to selection of an actionable item, displaying, by the processor, a list of business objects in a tree area, the business objects including at least one expandable business object; and
in response to selection of the at least one expandable business object, expanding, by the processor, the at least one expandable business object to display a hierarchical tree including attributes of the selected at least one expandable business object in the tree area.

2. The method of claim 1, further comprising:
displaying textual information of the business object in a description area.

3. The method of claim 1, wherein the expanded business object of the hierarchical tree includes a first portion of tree branches indicating actions of the expanded business objects, and wherein the action is specific to the expanded business object.

4. The method of claim 1, wherein the expanded business object of the hierarchical tree includes a second portion of tree branches indicating functions of the expanded business object, and wherein the functions are generic for all business objects.

5. The method of claim 1, wherein the expanded business object of the hierarchical tree includes a third portion of tree branches indicating data objects of the expanded business object.

6. The method of claim 1, wherein the expanded business object of the hierarchical tree includes a fourth portion of tree branches indicating sub-objects of the expanded business object.

7. The method of claim 6, wherein at least one of the sub-objects is expandable, and wherein when the at least one of the sub-objects is expanded, the expanded sub-objects include at least one of an action, a function, a data object, and a further sub-object.

8. The method of claim 2, wherein if the business object is selected, the description area displays the text information of the business object.

9. A computer system, comprising:
a processor that is configured to display an business object explorer within a development studio and to:
display a control bar including actionable items;
in response to selection of an actionable item, display a list of business objects in a tree area, the business objects including at least one expandable business object; and
in response to selection of the at least one expandable a business object, expand the at least one expandable business object to display a hierarchical tree including attributes of the selected at least one expandable business object in the tree area.

10. The computer system of claim 9, further configured to display textual information of the business object in a description area.

11. The computer system of claim 9, wherein the expanded business object of the hierarchical tree includes a first portion of tree branches indicating actions of the expanded business objects, and wherein the action is specific to the expanded business object .

12. The computer system of claim 9, wherein the expanded business object of the hierarchical tree includes a second portion of tree branches indicating functions of the expanded business object, and wherein the functions are generic for all business objects.

13. The computer system of claim 9, wherein the expanded business object of the hierarchical tree includes a third portion of tree branches indicating data objects of the expanded business object.

14. The computer system of claim 9, wherein the expanded business object of the hierarchical tree includes a fourth portion of tree branches indicating sub-objects of the expanded business object.

15. The computer system of claim 14, wherein at least one of the sub-objects is expandable, and wherein when the at least one of the sub-objects is expanded, the expanded sub-objects include at least one of an action, a function, a data object, and a further sub-object.

16. The computer system of claim 10, wherein if the business object is selected, the description area displays the text information of the business object.

17. A machine-readable non-transitory storage medium having stored thereon machine-executable codes that, when executed, perform a method for displaying an business object explorer within a development studio, the method comprising:
displaying, by a processor, a control bar including actionable items;
in response to selection of an actionable item, displaying, by the processor, a list of business objects in a tree area, the business objects including at least one expandable business object; and
in response to selection of the at least one expandable business object, expanding the at least one expandable business object to display a hierarchical tree including attributes of the selected at least one expandable business object in the tree area.
